(19) United States
(12) Patent Application Publication
(10) Pub. No.: US 2007/0131083 A1
(43) Pub. Date: Jun. 14, 2007

(54) Alternative tuning device for stringed musical instruments

(76) Inventor: Alasdair James Bryce, Bradford (GB)

Correspondence Address: Alasdair Bryce, 74 Branksome Drive, Shipley, Bradford, BD18 4BE, GB

(21) Appl. No.: 11/605,117

(22) Filed: Nov. 29, 2006

(30) Foreign Application Priority Data
Dec. 10, 2005 (GB) GB0525207.7

(51) Int. Cl. G10D 3/00

(52) U.S. Cl. 84/313

(57) ABSTRACT

A device which attaches to the non-vibrating part of specific string(s) of suitable stringed musical instruments and which enables the musician to repeatably apply alternative predetermined tension states to the string(s), so as to selectively apply a known increment in pitch without the continual need for discerning re-tuning processes.

### CROSS-REFERENCE TO OTHER RELATED APPLICATIONS

This application relates to and claims priority from GB Patent Application Number GB 0525207.7, filed on Dec. 10, 2005, disclosure of which is incorporated herein by reference.

### BACKGROUND OF THE INVENTION

1. Field of the Invention

This invention relates to a means of easily applying alternative pre-determined tension states upon the strings of various types of fretted or unfretted stringed musical instruments such as electric guitars, acoustic guitars, bass guitars, lap-steel guitars, banjos and many others.

Stringed musical instruments, such as guitars, employ a plurality of strings which are anchored and tensioned so as to produce, when plucked, a corresponding series of open notes for which customary tunings have evolved. Such tunings are known to musicians and largely determine the fingering patterns for those strings so as to produce the desired combinations or progressions of notes.

Musicians may occasionally choose to alter the relative tuning of the strings for the purpose of expanding their musical capability. Conventionally, such alterations of pitch would involve readjusting the tension, and thus pitch, of the specific string(s) either by ear, or with the assistance of a tuning fork or electronic tuner. In order to avoid this critical readjustment process, various means of applying alternative pre-determined tension states upon the strings have been developed and are known in the prior art.

2. Description of the Related Art

Despite offering the benefits of applying alternative pre-determined tension states, the various devices known in the prior art all require installation of specialist equipment upon a given instrument so as to provide this function. For the purposes of this document, the word ‘installation’ is taken to mean an attachment process which, at the very least, requires a string to be de-tensioned and released from the instrument but may also mean the requirement for the use of a tool and may further mean the requirement for some modification to the host instrument, such as the drilling of a hole for example. Installation is thus undesirable because: it may be time-consuming and inflexible; it may require the use of specialist tools or skill, and; it may impair the host instrument in such a way that it can not be returned to it's original condition.

Similarly, the devices known in the prior art may only be suitable for certain types or models of instrument, may be limited in use to designated strings, may be rather obtrusive when fitted or, may introduce tuning instability in service.

Accordingly, it is the object of this invention to provide a means of repeatably applying alternative pre-determined tension states upon the strings of suitable musical instruments: which requires no installation upon the host instrument; which may be readily fitted and removed as preferred; which may be used on virtually any type or model of instrument; which may be used on any string, or multiples of strings, and; which would be unobtrusive when in use.

### BRIEF SUMMARY OF THE INVENTION

To achieve the foregoing objects, the present invention comprises of a device which: attaches solely to the string(s) at a point beyond either the nut or the bridge of the instrument; may be readily detached from said string(s); may attach to any preferred string(s); may be used in multiples over a number of strings, and which; may provide a repeatable incremental pitch change purely by means of it's engagement upon the string(s).

The fact of locating such a device purely upon the string(s) facilitates a universal application in that whereas virtually all design attributes vary between different instruments, models and manufacturers, the strings must essentially be the same. By providing for rapid attachment and detachment of the device, the musician may apply predetermined tension/pitch states to any string of any instrument instantly.

### BRIEF DESCRIPTION OF THE SEVERAL VIEWS OF THE DRAWING

FIG. 1 is a plan view of a generic stringed musical instrument showing the two possible attachment points for the invention;

FIG. 2 is an isometric view of the invention as attached to one string, as seen generally from above;

FIG. 3 is an isometric view of the invention shown in isolation, as seen generally from below;

FIG. 4 is an isometric exploded view of the invention, as seen generally from above;

FIG. 5 is an isometric exploded view of the invention, as seen generally from below;

FIG. 6 is a sectional view taken upon line 2-2 showing the invention in the high-tension state;

FIG. 7 is a sectional view taken upon line 2-2 showing the invention in the low-tension state;

FIG. 8 is a sectional view taken upon line 1-1 showing the invention in the high-tension state;

FIG. 9 is a sectional view taken upon line 1-1 showing the invention in the low-tension state;

FIG. 10 is a view taken upon arrow 3 showing the underside of the invention, shown relative to an attached string and an adjacent string.

### DETAIL DESCRIPTION OF THE INVENTION

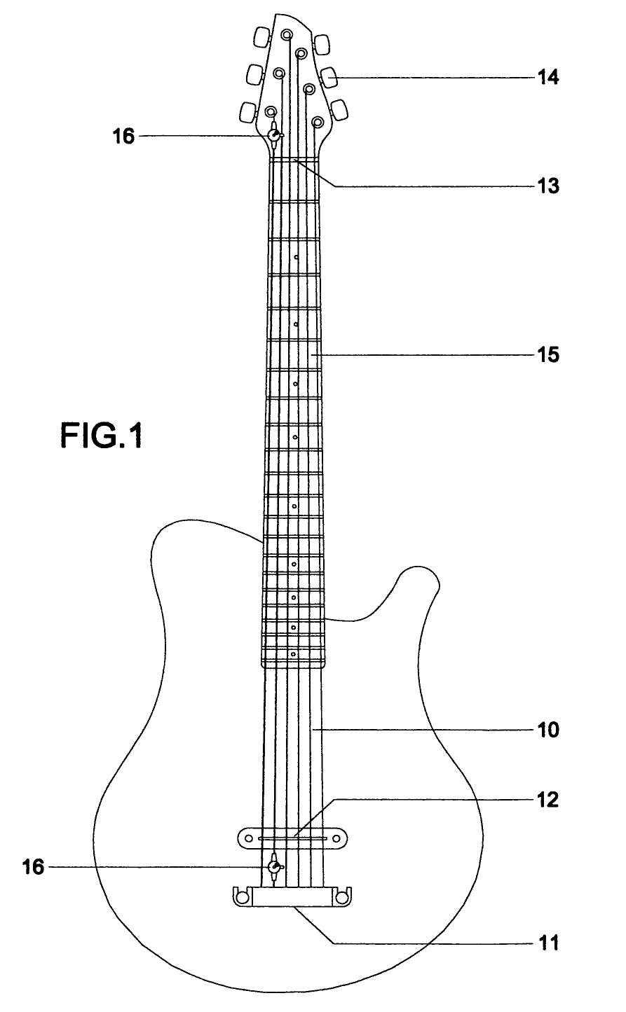

Referring in detail to the drawings, FIG. 1 illustrates a stringed musical instrument wherein a plurality of strings (generally) 10 are anchored at tailpiece 11, pass over bridge 12, extend longitudinally over finger-board 15, pass over nut 13 and are then anchored upon tuning machines 14. Tuning machines 14 are manually operable so as to provide fine control over the tension of the string thereby enabling the musician to ‘tune’ the instrument. Bridge 12 and nut 13 constitute breakpoints which define the scale-length of the vibrating part of the string which is manipulated by the musician during performance. The lengths of string between: the tailpiece 11 and bridge 12, and; the nut 13 and tuning machine 14, exist due to the need to anchor and tension the ends of the string independently from defining the playable scale-length. It can be understood, therefore, that a device fitted to either of these two parts of the string could affect the tension, and thus pitch, of the playable part of the string, without causing interference or obstruction. Such a device (16) is shown fitted in both of these locations and represents an embodiment of the present invention.

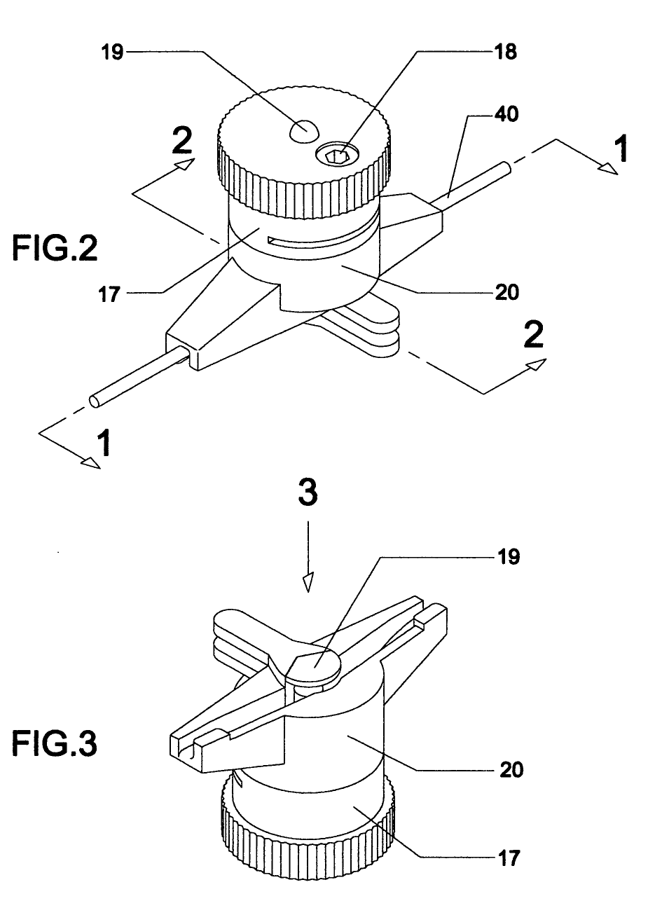

FIG. 2 illustrates the assembled device and shows the relative arrangement of body 20, thumbwheel 17, piston 19, set-screw 18 and string 40.

FIG. 3 also illustrates the assembled device and shows body 20, thumbwheel 17 and piston 19.

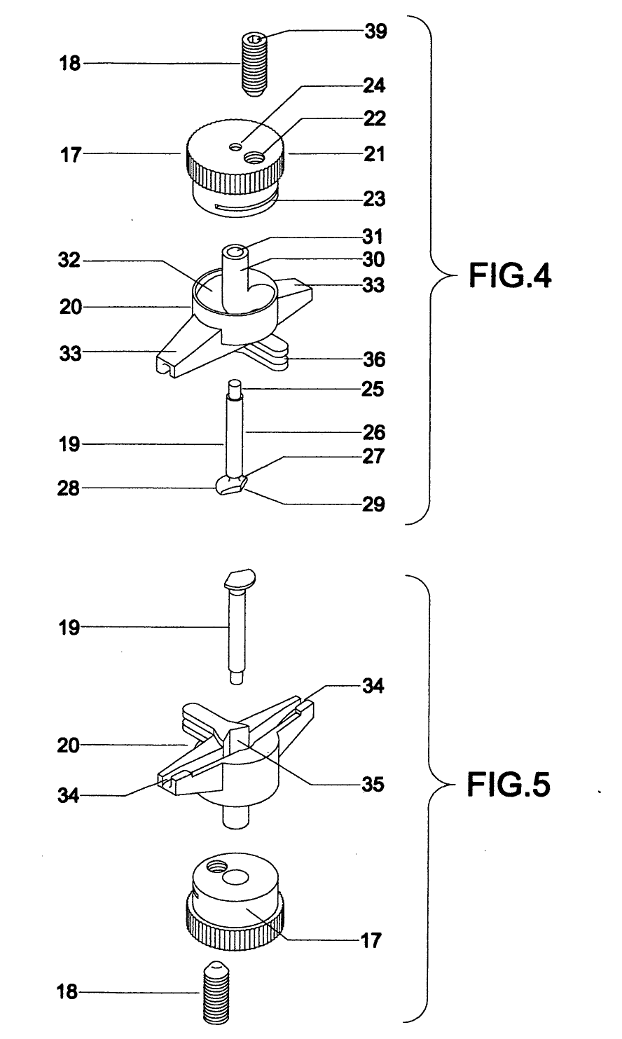

With reference to FIG. 4, thumbwheel 17 is a cylindrical component adapted with a protruding knurled flange 21, tapped hole 22, slit 23 and counter-bored hole 24. It is envisaged that this component would be turned from brass and plated to the desired finish. Set-screw 18 is a proprietary high tensile steel set screw with a typical hexagonal recess 39 to accept corresponding hexagonal key means of rotation. Piston 19 is essentially a shaft adapted with shank 26, reduced shank 25 at one end, and further adapted with a reduced diameter neck 27 and protruding flange 28, with machined facets 29, at the opposite end. It is envisaged that this component would be turned from stainless steel. Body 20 is adapted with a raised collar 30 and concentric hole 31, about which helical channel 32 is orientated. Body 20 is further adapted with protruding arms 33 and with a transverse-facing protrusion 36. It is envisaged that body 20 would be produced in stainless steel as a metal injection moulding. This process will provide the level of definition and finish necessary for a part of these compact dimensions and it will also enable the use of a material of appropriate surface hardness. The invention is assembled by means of locating the shank 26 of piston 19 through the concentric hole 31 of body 20 and into the counter-bored hole 24 of thumbwheel 17, at which point the reduced shank 25 is flared by means of a staking operation, thus making the assembly captive. Finally, set-screw 18 is located into tapped hole 22 of thumbwheel 17 and is held tight by means of an interference generated by the prior closure about slit 23.

FIG. 5 also shows body 20, thumbwheel 17, piston 19 and set-screw 18, whilst also illustrating guide forms 34 and general cavity form 35 of body 20.

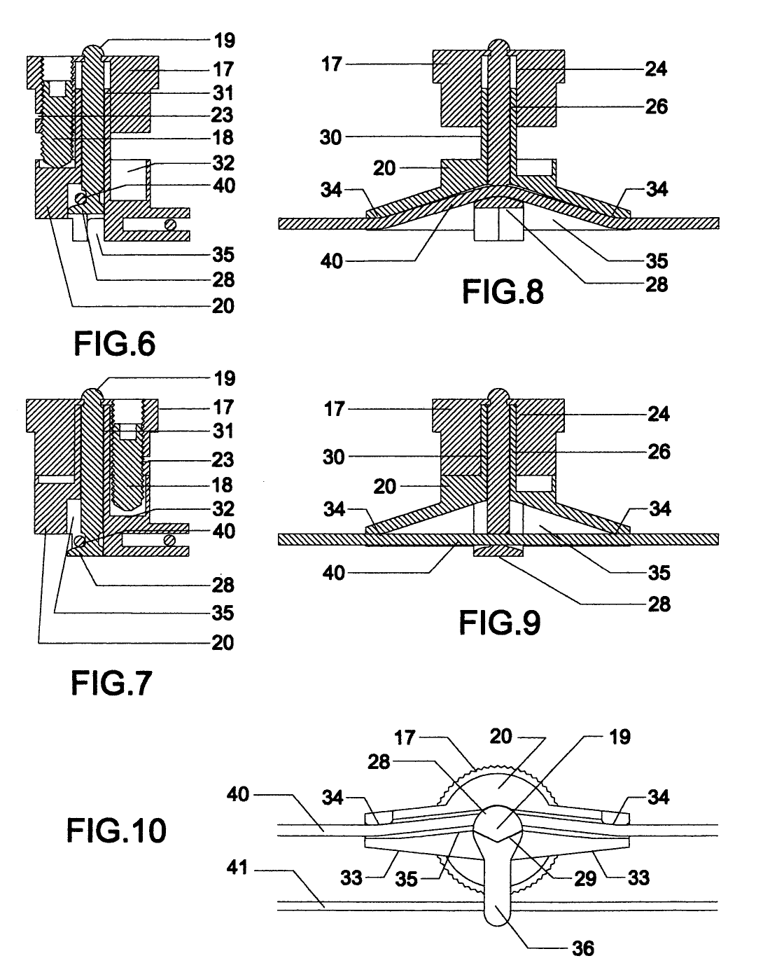

With reference to FIG. 6 and FIG. 7, the principle function of the invention involves the longitudinal travel of piston 19 through concentric hole 31 of body 20. It can be understood that as the piston rises, flange 28 displaces and thus elongates string 40 resulting in an increase in tension which causes a corresponding rise in pitch from the vibrating part of the string. This effect can be understood by comparing FIG. 7, which illustrates the invention in the low-tension state, with FIG. 6 which illustrates the invention in the high-tension state and at the extent of it's travel, where string 40 is fully displaced into corresponding cavity form 35. The longitudinal travel of piston 19 is achieved by means of the rotation of thumbwheel 17. Set-screw 18 protrudes from the underside of thumbwheel 17 and locates into helical channel 32. Helical channel 32 is essentially ‘C’ shaped in plan, thus restricting set-screw 18 to nominally 270 degrees of rotation. Helical channel 32 is further adapted so that it's bottom surface gradually rises in the form of a partial helix. Consequently, as thumbwheel 17 is rotated, the engagement of set-screw 18 upon helical channel 32 causes thumbwheel 17 to rise and thus piston 19 rises accordingly. Fine control over the extent of travel of piston 19 is of critical importance and allows a specific change in tension to be applied to the string. In practice, strings of different gauges will offer a different pitch change to a given piston travel and musicians may desire differing pitch changes for a particular effect. For this reason, the invention may be calibrated to provide a specific pitch change when used with a specific gauge of string. Such calibration is achieved by the adjustment of set-screw 18. With reference to FIG. 7, it can be understood that when the invention is set in the low-tension state, set-screw 18 does not make contact with helical channel 32 and, in this position, thumbwheel 17 engages upon body 20. As thumbwheel 17 is progressively rotated, set-screw 18 will make contact with helical channel 32 at a point dependant upon it's protrusion from the underside of thumbwheel 17. Thus, in the high-tension state, the extent of travel of piston 19 is determined solely by the adjusted setting of set-screw 18, as illustrated in FIG. 6. In order to prevent any unwanted rotation of set-screw 18 during use, thumbwheel 17 is adapted with slit 23 which, by means of it's partial closure prior to assembly, creates an interference fit to the thread of set-screw 18, thus acting in the manner of a locknut. In use, when the invention is set in the low-tension state, the string of the host instrument is tuned to the lower of the two pitches by way of it's own tuning machine. Then, when the invention is set in the high-tension state, the string is tuned to the higher of the two pitches by means of set-screw 18. After this setting up exercise, either of the two pitches can immediately be selected simply by rotating thumbwheel 17.

FIG. 8 and FIG. 9 illustrate that the points of the device which contact the string are adapted with smooth and radiused surfaces so as to minimise friction and also to prevent any permanent deformation to the string 40. Hence, guide forms 34 and protruding flange 28 are produced with a smooth surface finish and are shaped in sympathy with the path of the string in the high-tension state. Similarly, general cavity form 35 of body 20 is profiled so as to accept the string 40 in it's fully displaced state. The proportionate upward projection of raised collar 30 co-operates with shank 26 and counter-bored hole 24 to ensure that thumbwheel 17 remains axially true during travel and, hence, free from any unwanted play and the resultant inconsistency which that would cause.

FIG. 10 shows how the invention locates onto the designated string 40 at the two outer guide forms 34 of body 20, and below flange 28 of piston 19. These three points effectively apply a slight deviation to the string. FIG. 10 also indicates how the invention could be fitted simply by momentarily reducing tension in the string so that it could be slipped over the protruding flange 28, at which point re-tensioning of the string will serve to hold the invention positively. Because piston 19 is adapted with machined facets 29 which engage into general cavity form 35, no rotational movement is transferred from thumbwheel 17 to piston 19 during operation. FIG. 10 further indicates the function of transverse facing protrusion 36 of body 20 which locates over an adjacent string 41 so as to prevent any axial rotation about the designated string when the invention is being operated. In this case such a location is loose and non-bearing so as avoid any friction during relative travel of the designated and adjacent strings. Protruding arms 33 to body 20 are adapted in tapering, skeletal form so as to avoid contact with adjacent strings where the design of the instrument is such that the strings may converge as they pass from the nut to their individual tuning machines. This tapering, skeletal form would also allow the invention to be used in multiples over a number of strings, in close proximity.

Because of the differing gauges of string in use on various stringed musical instruments, it is foreseeable that a number of different variants of the invention may be required. Whereas the strings commonly used on many instruments such as electric guitars, acoustic guitars, pedal steel guitars and banjos are generally comparable, the strings used on other instruments such as bass guitars are of considerably heavier gauge. Thus, specific variants of the invention may be adapted with differing travel/calibration characteristics to suit specific instrument groups.

The above description illustrates the technical attributes of an embodiment of the invention and describes the means of repeatably applying alternative tension states upon the strings of a wide variety of stringed musical instruments whereby simplicity of attachment and removal, operational adaptability and scope of compatibility exceed those of the examples known in the prior art.

The foregoing disclosure has been set forth merely to illustrate the invention and is not intended to be limiting in either application or embodiment. For example, the invention may also be embodied in such a way that a plurality of strings are affected, if it's function is equivalent. As a further example, the invention may also be embodied with friction-reducing rollers/materials at the contact points. Additional modifications which occur to those skilled in the art may differ from those disclosed herein without departing from the spirit or scope of the inventive concept as defined by the appended claims and their equivalence.

What is claimed is:

1. A device for applying alternative predetermined tension states upon the string(s) of various types of stringed musical instruments comprising:
a main body, said main body adapted for engagement upon those portions of the string(s) which extend inwardly from their extreme anchorpoints until reaching the breakpoints which determine the vibrating or sounding part of the string;
control handle means, said control handle means to enable the user to manually alternate between the predetermined tension states which the device applies to the string(s);
actuator means, said actuator means adapted for engagement upon said string(s), said actuator means to deflect said string(s) in relation to said engagement points of said main body and in accordance with the operation of said control handle means;
calibration means, said calibration means to enable at least one of the tension states to be critically pre-determined during an adjustment process, said calibration means to retain the setting of said adjustment process during normal use of the device,
wherein, said device engages directly onto the string(s) but makes no physical contact with any other part of the instrument to which it is fitted, and
wherein, operation of the control handle quickly and repeatably applies a known increment in pitch to the vibrating or sounding part of the string without the need for any discerning adjustment process.

2. A device for applying alternative predetermined tension states upon the string(s) of various types of stringed musical instruments, as in claim 1, but
wherein, said main body and said actuator means are further adapted so that their means of engagement upon said string(s) does not fully enclose said string(s) at any point, and
wherein, the device may thus be fitted to and removed from the host instrument without the need to release the end of any string from it's anchorpoint.

3. A device for applying alternative predetermined tension states upon the string(s) of various types of stringed musical instruments, as in claim 2, but
wherein, said engagement means of said main body and of said actuator means are relatively adapted to co-operate with said string(s) such that the tendancy of said string(s) to stay taught and straight under tension serves to secure the device upon said engagement points, and
wherein, the device may thus be fitted to and removed from the host instrument without: the need to dismantle or assemble any part of the device, or; the need to disturb the calibrated settings of the device, or; the need to use any tool in the process.

4. A device for applying alternative predetermined tension states upon the string(s) of various types of stringed musical instruments, as in claim 1, but
wherein, the control handle means comprises of a rotary knob, whereupon the rotation of said rotary knob is restricted to no more than one full turn by means of two, or more, clearly discernable stop points, said stop points providing tactile indication of said alternative predetermined tension states.

5. A device for applying alternative predetermined tension states upon the string(s) of various types of stringed musical instruments, as in claim 1, but
wherein, said main body is further adapted with protrusions which are orientated substantially perpendicularly to the operative string, said protrusions extending towards an adjacent string whereupon said protrusions do not fully enclose said adjacent string but engage lightly on opposing surfaces of said adjacent string thus preventing the device from rotating axially upon the operative string and thereupon maintaining consistent orientation of the device in service.

6. A device for applying alternative predetermined tension states upon the string(s) of various types of stringed musical instruments comprising:
rotary control means, said rotary control means to drive the device between the alternative predetermined tension states which the device applies to the string(s);
a main body, said main body adapted to co-operate with said rotary control means whereupon said rotary control means has radial and axial freedom of movement relative to said main body, said main body further adapted with an inclining surface located opposite to the radial plane of said rotary control means, said inclining surface to be substantially helical in form, said substantially helical form to be limited to no more than one full rotation about said axis;
calibration means, said calibration means to enable at least one of the tension states to be critically pre-determined during an adjustment process, said calibration means to comprise of a threaded screw, said threaded screw to project from said rotary control means and to engage upon said inclined surface of said main body, and
wherein, said string is selectively elongated according to the axial displacement of said rotary control means whereupon the extent of said axial displacement is dependant upon the adjustment of said threaded screw and the relative engagement of said threaded screw upon said inclining surface of said main body.

7. A device for applying alternative predetermined tension states upon the string(s) of various types of stringed musical instruments comprising:
a rotary control knob, said rotary control knob incorporating concentric hole therethrough, said control knob incorporating an axially parallel threaded hole therethrough;
an axial slider rod, said axial slider rod to incorporate lower location form to engage upon said string, said axial slider rod to cooperate with said concentric hole in said rotary control knob, said axial slider rod to incorporate upper flange means to bear upon said rotary control knob;
an adjustment screw, said adjustment screw to engage positively by screw thread means with said axially parallel threaded hole in said rotary control knob, said adjustment screw to be rotatably adjustable within said axially parallel threaded hole of said rotary control knob whereupon said adjustment will control the outward projection of the tip of said adjustment screw from said rotary control knob;
a body, said body to incorporate outer points for engagement upon said string, said main body to incorporate a cavity area to provide for displacement of said string between said outer engagement points, said main body to incorporate central hole therethrough to co-operate with said axial slider rod, said main body to incorporate inclining surface for co-operation with the tip of said adjustment screw, and
wherein, said string locates upon said outer engagement points of said main body and may then be displaced at a point between said outer engagement points by means of the engagement of said lower location form of said axial slider rod whereupon said axial slider rod rises as said upper flange means bears upon said rotary control knob wherein the ultimate displacement is defined by the extent of projection of the tip of said adjustment screw according to it's travel upon said inclining surface of said main body.
